(19) United States
(12) Patent Application Publication
(10) Pub. No.: US 2006/0022130 A1
(43) Pub. Date: Feb. 2, 2006

(54) Microfluidic devices and methods with integrated electrical contact

(75) Inventors: Luc Bousse, Los Altos, CA (US); Mingqi Zhao, Cupertino, CA (US); Jing Ni, Sunnyvale, CA (US)

Correspondence Address: U.P. Peter Eng (Wilson Sonsini Goodrich Rosati), 650 Page Mill Road, Palto Alto, CA, 94304-1050, US

(73) Assignee: PREDICANT BIOSCIENCES, INC., a Delaware Corporation, South San Francisco, CA (US)

(21) Appl. No.: 10/903,248

(22) Filed: Jul. 29, 2004

(51) Int. Cl. H01J 49/00

(52) U.S. Cl. 250/288

(57) ABSTRACT

Microfluidic devices provide substances to a mass spectrometer. The microfluidic devices include a substrate having at least one microchannel, a cover arranged on a surface of the microchannel, and at least one electrical potential source. Some embodiments include a microchannel widened at an outlet. Other embodiments position the electrical potential source along a surface of the cover. Still other embodiments include a well in which an electrode and a membrane are disposed. The various embodiments provide stable electrospray ionization of substances from a microfluidic device to a mass spectrometer.

### FIELD OF THE INVENTION

The present invention relates generally to interfaces between microfluidic devices and mass spectrometers. More specifically, the invention relates to improved microfluidic devices for providing electrospray ionization of substances to a mass spectrometer.

### BACKGROUND OF THE INVENTION

The use of microfluidic devices such as microfluidic chips is becoming increasingly common for such applications as analytical chemistry research, medical diagnostics and the like. Microfluidic devices may be used for separation and analysis of sample sizes as small as a few nanoliters or less and are thus generally quite promising for applications such as proteomics and genomics. One way to analyze substances using a microfluidic device is to mix and/or separate substances on the microfluidic device and then pass the substances from the device to a mass spectrometer (MS). Such a technique often uses electrospray ionization (ESI) to pass the substances from the microfluidic device to the MS.

Some microfluidic devices simply act as a platform for delivering substances to a MS. In other words, one or more substances (typically fluids) are placed on such a microfluidic device and are made to move across the device and interface with the MS, typically by ESI from an ESI tip on the microfluidic device. Such microfluidic devices work well for the simple purpose of providing one or more substances to a MS. In other applications, however, it is advantageous to use microfluidic devices to separate, mix and/or otherwise manipulate one or more substances on the device and then provide one or more of the substances to the MS via an ESI tip. Such microfluidic devices typically include multiple fluid reservoirs connected to microchannels, with fluids being deposited in one or more reservoirs and driven along one or more microchannels using electrokinetic forces, pumps and/or other driving mechanisms. After passing through one or more microchannels and being separated, a fluid (or fluids) is then passed from an ESI tip of the microfluidic device to a MS for analysis.

Electrospray ionization generates ions for mass spectrometric analysis. Some of the advantages of ESI include its ability to produce ions from a wide variety of samples such as proteins, peptides, small molecules, drugs and the like, and its ability to transfer a sample from the liquid phase to the gas phase, which may be used for coupling other chemical separation methods, such as capillary electrophoresis (CE), liquid chromatography (LC), or capillary electrochromatography (CEC) with mass spectrometry. One of the challenges in developing microfluidic devices has been to combine the ability of a device to separate, mix or otherwise manipulate sample substances with its ability to provide those substances to a MS device via ESI.

One problem sometimes encountered in currently available microfluidic ESI devices is the challenge of applying a potential to substances in the device with a stable ionization current while minimizing dead volume and minimizing or preventing the production of bubbles in the channels or in the droplet at the microchannel outlet. A potential may be applied to substances, for example, to move them through microchannel(s) in a microfluidic device, to separate substances, to provide electrospray ionization, or typically a combination of all three of these functions. Some microfluidic devices use a conductive coating on the outer surface of the chip or capillary to achieve this purpose. The conductive coating, however, often erodes or is otherwise not reproducible. Furthermore, bubbles are often generated in currently available devices during water electrolysis and/or redox reactions of analytes. Such bubbles adversely affect the ability of an ESI device to provide substances to a mass spectrometer in the form of a spray having a desired shape. In particular, the presence of one or more bubbles in the microfluidic channel of a microfluidic device can interrupt both the flow and the electrical current needed to sustain electrospray ionization, thus destabilizing the electrospray and disabling the device.

Minimizing dead volume at the tip of the microfluidic device, as mentioned above, enhances sensitivity and separation performance of a microfluidic device but has proven difficult. Another difficulty in developing microfluidic devices with ESI tips is to minimize or eliminate electrical breakdown between the ESI tip and the MS counter electrode.

Therefore, it would be desirable to have improved microfluidic devices that provide ESI of substances to MS devices and that are easily manufactured. Ideally, such microfluidic devices would include means for ESI that provide desired spray patterns to an MS device while minimizing electrical breakdown between the ESI tip and the MS counter electrode. Also ideally, microfluidic devices would include means for providing a charge to substances without generating bubbles and while minimizing dead volume. At least some of these objectives will be met by the present invention.

### BRIEF SUMMARY OF THE INVENTION

In various embodiments, microfluidic devices include improved mechanisms for causing substances to pass from the microfluidic device to the MS via electrospray ionization (ESI). Generally, microfluidic devices include a substrate comprising at least one microchannel, a cover arranged on a surface of the substrate, at least one outlet in fluid communication with the microchannel for allowing egress of substances, and at least one tip surface extending the cover beyond the outlet. Devices also typically include one or more electrical potential sources, such as electrodes, to provide ESI. Improved design configurations and the like provide for enhanced ESI from a microfluidic device that may also provide for separation and/or other manipulation of substances.

In one aspect of the invention, a microfluidic device for providing one or more substances to a mass spectrometer for analysis includes: a substrate comprising at least one layer, the substrate including at least one microchannel, wherein the substances are movable within the at least one microchannel; a cover arranged on a surface of the substrate, the cover including at least one electrical potential source; at least one outlet in fluid communication with the microchannel for allowing egress of the substances from the microchannel; and at least one tip surface extending the cover beyond the outlet. In this device, the microchannel in fluid communication with the outlet widens from a first cross sectional dimensions along the majority of its length to a second, wider cross sectional dimensions at the outlet.

In some embodiments, the microchannel is enclosed between the substrate and the cover. Also in some embodiments, the at least one microchannel comprises at least two intersecting microchannels. In these or other embodiments, the at least one microchannel may include a first microchannel in fluid communication with a first outlet and having first cross sectional dimensions and second, wider cross sectional dimensions, and at least a second microchannel in fluid communication with a second outlet disposed at the tip surface. Optionally, the second microchannel may include at least one substance, such as but not limited to a cross-linked polyacrylamide, an agarose gel, a linear polyacrylamide, a cellulose polymer, polyethylene oxide, polyvinylpyrrolidone and other hydrophilic polymer solutions, for preventing substances exiting the first outlet from entering the second outlet. Alternatively, the second microchannel may have negatively charged walls for directing a buffer through the second microchannel to prevent substances exiting the first outlet from entering the second outlet. In another embodiment, the first microchannel may have positively charged walls, and the second microchannel may have walls with essentially no charge or a very low charge, for preventing substances from entering the second outlet.

In some embodiments, the cover comprises at least one material selected from the group consisting of glass, silicon, ceramic, polymer, copolymer, silicon dioxide, quartz and silica. In some embodiments, for example, a polymer may be used, such as but not limited to cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ or other acrylic-based polymers.

In some embodiments, the at least one electrical potential source of the cover comprises a strip of material disposed across the outlet. In one embodiment, for example, the electrical potential source comprises a strip of metal film. In another embodiment, the electrical potential source comprises a strip of conductive ink. In various embodiments, the electrical potential source may be embedded in the cover, coupled with the cover via adhesive or coupled with the cover via any other suitable means.

In another aspect of the invention, a microfluidic device for providing one or more substances to a mass spectrometer for analysis includes: a substrate comprising at least one layer, the substrate including at least one microchannel, wherein the substances are movable within the at least one microchannel; a cover arranged on a surface of the substrate and having a first surface in contact with the substrate and a second surface opposite the first surface; at least one outlet in fluid communication with the microchannel for allowing egress of the substances from the microchannel; at least one tip surface extending the cover beyond the outlet; and at least one electrical potential source disposed on the second surface of the cover and ending near a distal end of the tip. Again, in some embodiments, microchannel(s) are enclosed between the substrate and the cover. Also in some embodiments, the at least one microchannel comprises at least two intersecting microchannels. In some embodiments, the at least one microchannel comprises at least two microchannels, each in fluid communication with a different outlet.

In some embodiments, the tip includes a V-shaped edge surface for providing electrospray ionization of the substances to the mass spectrometer. Optionally, one end of the electrical potential source may be disposed at the V-shaped edge surface. In some embodiments, the one end of the electrical potential source is recessed within the V-shaped edge surface. In any such embodiments, the electrical potential source may comprise a conductive wire.

In an alternative embodiment, the tip includes at least one hole through the cover. The electrical potential source may comprise a conductive wire shaped to extend into the hole. Alternatively, the electrical potential source may comprise a conductive plate having a post extending into the hole. The electrical potential source in any embodiment may be coupled with the cover via any suitable means, such as by adhesive or the like.

In another aspect of the invention, a microfluidic device for providing one or more substances to a mass spectrometer for analysis includes: a substrate comprising at least one layer; a cover arranged on a surface of the substrate; at least one outlet in fluid communication with the microchannel for allowing egress of the substances from the microchannel; and at least one tip surface extending the cover beyond the outlet. The substrate, in turn, includes at least one microchannel, wherein the substances are movable within the at least one microchannel; and at least one electrode reservoir in fluid communication with the microchannel, the electrode reservoir having a membrane, conductive fluid separated from the microchannel by the membrane, and an electrode. This microfluidic device may be made of any suitable materials, such as those listed above, and may have any of the other device characteristics described above, such as multiple intersecting channels and the like.

In some embodiments, the electrode reservoir comprises a reservoir portion containing the membrane, the conductive fluid and the electrode and a bridging channel between the reservoir portion and the microchannel, the bridging channel having a smaller dimensions than the reservoir portion. In some embodiments, the membrane is disposed at the bottom of the reservoir portion, immediately adjacent the bridging channel, and the membrane comprises nanopores configured to allow only small ions to pass through the membrane from the reservoir portion to the bridging channel. In some embodiments, at least part of the electrode is disposed in the reservoir portion in contact with the conductive fluid. Some embodiments may optionally further include a membrane fixture for holding the membrane in place at the bottom of the reservoir portion. Alternatively, the membrane may be held in place at the bottom of the reservoir portion via adhesive.

In another aspect of the invention, a microfluidic device for providing one or more substances to a mass spectrometer for analysis includes: a substrate comprising at least one layer, a cover arranged on a surface of the substrate; a first outlet in fluid communication with a first microchannel for allowing egress of the substances from the first microchannel; at least a second outlet in fluid communication with the second microchannel for allowing electrical current from the second microchannel; and at least one tip surface extending the cover beyond the outlet. The substrate includes at least a first microchannel, wherein the substances are movable within the first microchannel, and at least a second microchannel coupled with an electrical contact and including at least one substance for preventing the substances in the first microchannel from passing into the second microchannel.

The at least one substance in the second microchannel may comprise, for example, at least one of a cross-linked polyacrylamide, an agarose gel, or a viscous polymeric solution such as linear polyacrylamides, cellulose polymers, polyethylene oxide, polyvinylpyrrolidone, or other hydrophilic polymer solutions. Alternatively, the at least one substance in the second microchannel may comprise a buffer, and the second microchannel may have negatively charged walls for directing the buffer through the second microchannel to prevent the substances exiting the first outlet from entering the second outlet.

In another aspect of the invention, a method of making a microfluidic device for providing one or more substances to a mass spectrometer for analysis involves fabricating a substrate, fabricating a cover having at least one tip surface, and applying the cover to the substrate. Fabricating the substrate includes forming at least one microchannel having a microfabricated surface and forming an outlet in fluid communication with the microchannel and disposed along an edge surface of the substrate. The microchannel in fluid communication with the outlet is formed so as to widen from a first cross sectional dimensions along the majority of its length to a second, wider cross sectional dimensions at the outlet.

In some embodiments, fabricating the substrate comprises forming at least two intersecting microchannels. The substrate and/or cover may be fabricated from any suitable material or materials, such as but not limited to glass, silicon, ceramic, polymer, copolymer, silicon dioxide, quartz, silica and/or combinations thereof. Polymers may include, for example, cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and/or other acrylic-based polymers.

Some embodiments further involve coupling an electrical potential source with the device to move the substances through the microchannel by electrophoretic or electrokinetic mobility. For example, in some embodiments the electrical potential source comprises an electrical potential microchannel, the electrical potential microchannel containing at least one electrically charged substance. In some embodiments, the electrical potential microchannel exits the microfluidic device immediately adjacent the microchannel. The method may further involve disposing at least one substance in the electrical potential microchannel for preventing substances exiting the outlet from entering the electrical potential microchannel. For example, the at least one substance in the electrical potential microchannel may comprise a cross-linked polyacrylamide, an agarose gel, or a viscous polymeric solution such as linear polyacrylamides, cellulose polymers, polyethylene oxide, polyvinylpyrrolidone, or other hydrophilic polymer solutions. Alternatively, the at least one substance in the electrical potential microchannel may comprise a buffer, and the electrical potential microchannel may have negatively charged walls for directing the buffer through the electrical potential microchannel. In another embodiment, the first microchannel may have positively charged walls, and the second microchannel may have walls with essentially no charge or very little charge, for preventing substances from entering the second outlet.

In other embodiments, the electrical potential source comprises at least one electrode on the microfluidic device. For example, the at least one electrode may comprise a strip of material, such as a metal film or conductive ink, coupled with the cover so as to be disposed across the outlet. Such an electrode may be embedded in the cover, coupled with the cover via adhesive, or coupled with the cover via any other suitable means. In some embodiments, the at least one electrode provides potential for effecting at least one of electrophoretic separation of the substances and electrospray ionization. In other embodiments, the at least one electrode provides potential for effecting at least one of electrokinetic movement of the substances in the microchannel and electrospray ionization. The at least one electrode may comprise any suitable material or materials, such as but not limited to copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and/or other conductive polymers and conjugated polymers. In some embodiments, the at least one electrode provides the electrical potential without producing a significant quantity of bubbles in the substances.

In some embodiments, the method further involves making at least two connected microfluidic devices from one or more common pieces of starting material and separating the at least two microfluidic devices by cutting the common pieces of starting material. In various embodiments, the at least one microchannel may be formed by at least one of photolithographically masked wet-etching, photolithographically masked plasma-etching, embossing, molding, compression molding, injection molding, photoablating, micromachining, laser cutting, laser ablation, milling, die cutting, reel-to-reel methods, photopolymerizing and casting.

In another aspect of the invention, a method of making a microfluidic device for providing one or more substances to a mass spectrometer for analysis involves: fabricating a substrate; fabricating a cover having at least one tip surface, a substrate contacting surface, and an electrical potential surface opposite the substrate contacting surface; coupling at least one electrical potential source with the electrical potential surface; and applying the cover to the substrate. Fabricating the substrate comprises forming at least one microchannel having a microfabricated surface and forming an outlet in fluid communication with the microchannel and disposed along an edge surface of the substrate. The substrate and cover may generally be made of any materials and have any characteristics described above in various embodiments.

In some embodiments, the electrical potential source comprises at least one electrode. For example, fabricating the cover may involve forming a V-shaped edge surface in the tip surface, and the electrode may comprise a conductive wire with one end disposed in the V-shape. In another embodiment, fabricating the cover comprises forming a hole in the tip. In such embodiments, the electrode may optionally comprise a conductive wire shaped to extend into the hole. Alternatively, the electrode may comprise a conductive plate having a post extending into the hole. The electrode may comprise any suitable substance and may be used for separation of the substances and/or electrospray ionization. In some emobodiments, the electrode provides the electrical potential without producing a significant quantity of bubbles in the substances.

In yet another aspect of the invention, a method of making a microfluidic device for providing one or more substances to a mass spectrometer for analysis involves: fabricating a substrate; fabricating a cover having at least one tip surface, a substrate contacting surface, and an electrical potential surface opposite the substrate contacting surface; and applying the cover to the substrate. Fabricating the substrate comprises: forming at least one microchannel having a microfabricated surface; forming an outlet in fluid communication with the microchannel and disposed along an edge surface of the substrate; and forming at least one electrode reservoir in fluid communication with the microchannel, the electrode reservoir having a membrane, conductive fluid separated from the microchannel by the membrane, and an electrode.

A method of making a microfluidic device for providing one or more substances to a mass spectrometer for analysis, the method comprising: fabricating a substrate; fabricating a cover having at least one tip surface; coupling an electrical potential source with the device to move the substances through the microchannel by electrophoretic or electrokinetic mobility; and applying the cover to the substrate. Fabricating the substrate comprises forming at least one microchannel having a microfabricated surface and forming an outlet in fluid communication with the microchannel and disposed along an edge surface of the substrate.

In some embodiments, the electrical potential source comprises an electrical potential microchannel, the electrical potential microchannel containing at least one electrically charged substance. In some embodiments, the electrical potential microchannel exits the microfluidic device immediately adjacent the microchannel. Some embodiments further involve disposing at least one substance in the electrical potential microchannel for preventing substances exiting the outlet from entering the electrical potential microchannel. The substance may comprise, for example, a cross-linked polyacrylamide, an agarose gel, or a viscous polymeric solution such as linear polyacrylamides, cellulose polymers, polyethylene oxide, polyvinylpyrrolidone, or other hydrophilic polymer solutions. Alternatively, the substance in the electrical potential microchannel may comprise a buffer, and the electrical potential microchannel may have negatively charged walls for directing the buffer through the electrical potential microchannel. In another embodiment, the first microchannel may have positively charged walls, and the second microchannel may have walls with essentially no charge or very little charge, for preventing substances from entering the second outlet.

These and other aspects and embodiments of the present invention are described in further detail below.

### BRIEF DESCRIPTION OF THE DRAWINGS

FIG. 1A is a side view of a microfluidic device according to an embodiment of the present invention.

FIG. 1B is a top view of the microfluidic device in FIG. 1A.

FIGS. 2A-2E are top views demonstrating methods of making a microfluidic device according to two embodiments of the present invention.

FIG. 3A-3I are top views demonstrating alternative methods of making a microfluidic device according to two embodiments of the present invention.

FIGS. 4A-4D are top views demonstrating alternative method of making a microfluidic device according to two embodiments of the present invention.

FIGS. 5A-5C are top views of portions three embodiments of a microfluidic device having an electrode well, according to three embodiments of the present invention.

FIG. 5D is a side view of an electrode well as in FIGS. 5A-5C.

FIGS. 6A and 6B are top views of a microfluidic device and a tip of the device, respectively, having multiple microchannels and multiple wells according to one embodiment of the present invention.

### DETAILED DESCRIPTION OF THE INVENTION

Improved microfluidic devices and methods for making and using such devices provide one or more substances to a mass spectrometer (MS) for analysis. The microfluidic devices generally include a substrate and a cover (or a substrate having first and second surfaces or the like), at least one microchannel formed by the surfaces, an outlet at an edge of the surfaces, and at least one electrical potential source. In various embodiments, different features of the substrate, cover, outlet and/or electrical potential source are configured to enhance electrospray ionization (ESI) of substances from a microfluidic device to a MS device for analysis.

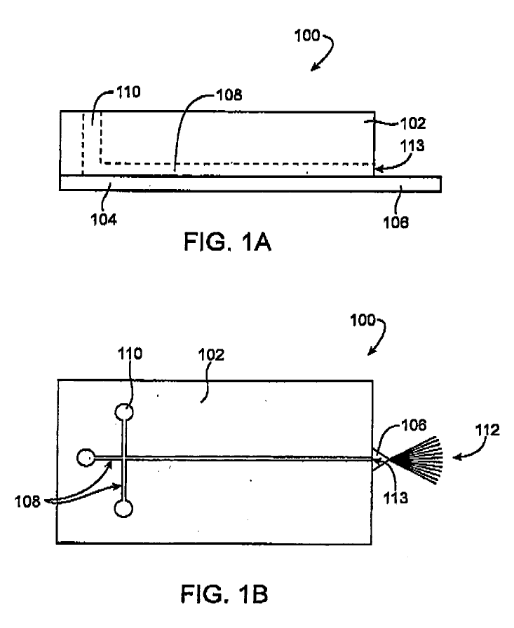

Referring now to FIGS. 1A and 1B, schematic illustrations of a side view and a top view, respectively, of a microfluidic device 100 comprising a substrate 102 and a cover 104 are shown. (The device 100 is not drawn to scale.) The substrate 102 includes one or more wells 10, into which substance(s) may be deposited, and one or more microchannels 108 through which substance(s) may be directed and in which substance(s) may be separated into constituent parts. At least one microchannel 108 is typically in fluid communication with an outlet 113 to allow egress of substance(s) from the microchannel 108. The cover 104, arranged on a surface of the substrate 102, may extend beyond an edge of the substrate 102 to form an ESI tip 106. As shown in FIG. 1B, an electrospray 112 of one or more substances may be provided from the ESI tip 106, to delivery the substance(s) to a MS device.

The term “substrate” as used herein refers to any material that can be microfabricated (e.g., dry etched, wet etched, laser etched, molded or embossed) to have desired miniaturized surface features, which may be referred to as “microstructures.” Microfabricated surfaces can define these microstructures and other, optionally larger structures. Microfabricated surfaces and surface portions can benefit from a dimensional tolerance of 100 μms or less, often being 10 μms or less, the tolerances of the microfabricated surfaces and surface portions more generally being significantly tighter than provided by dicing (substrate cutting or separating) techniques that may define adjacent portions and surfaces. Examples of microstructures include microchannels, which are described in further detail below. Microstructures can be formed on the surface of a substrate by adding material, subtracting material, a combination of both, pressing, or the like. For example, polymer channels can be formed on the surface of a glass substrate using photo-imageable polyimide.

Substrate 102 may comprise any suitable-material or combination of materials, such as but not limited to a polymer, a ceramic, a glass, quartz, fused silica, a metal, a composite thereof, a laminate thereof, or the like. Examples of polymers include, but are not limited to, polyimide, polycarbonate, polyester, polyamide, polyether, polyolefin, polymethyl methacrylates, other acrylic polymers, polyurethanes, polyacrylonitrile-butadiene-styrene copolymers, polystyrene, polyfluorocarbons, and combinations thereof. Furthermore, substrate 102 may suitably comprise one layer or multiple layers, as desired. When multiple substrate layers are provided, the layers will often be bonded together. Suitable bonding methods may include application of a combination of pressure and heat, thermal lamination, pressure sensitive adhesive, ultrasonic welding, laser welding, and the like. Generally, substrate 102 comprise any suitable material(s) and may be microfabricated by any suitable technique(s) to form any desired microstructure(s), shape, configuration and the like.

The term “cover” as used herein refers to one or more layers of any suitable material disposed on a surface of a substrate. In various embodiments, cover 104 may be disposed on an upper surface, a lower surface (as in FIGS. 1A and 1B), or any other suitable surface of substrate 102. In some embodiments, cover 104 encloses microchannels 108. Cover 104 generally comprises any suitable material, such as the materials described above in reference to substrate 102. Thus, cover 104 may comprise a polymer, a ceramic, a glass, a metal, a composite thereof, a laminate thereof, or any other suitable material or combination. As is described further below, in various embodiments cover 104 may comprise a simple, planar component without notable surface features, or may alternatively have one or more surface features, outlets or the like. Typically, the cover is bonded to the substrate, and such bonding can be achieved by any suitable method.

As mentioned above, in some embodiments substrate 102 includes one or more microchannels 108, at least one of which is in fluid communication with an outlet 113. Microchannel 108 (as with all microfluidic channels described herein) will often have at least one cross-sectional dimension (such as width, height, effective dimensions or dimensions) of less than 500 μm, typically in a range from 0.1 μm to 500 μm. As shown in FIG. 1B, substrate 102 may include a plurality of microchannels 108 defining one, two, or more than two intersections. Typically, substances are moved through microchannels 108 by electric charge, where they also may be separated, and the substances then exit device 100 via outlet 113 in the form of an electrospray 112 directed towards a mass spectrometer or other device. In some embodiments, outlet 113 may be located in a recessed area, which is recessed from an edge 103 of device 100. The recessed area generally serves the purpose of protecting the ESI tip 106, which extends beyond outlet 113, from being damaged or broken during manufacture or use. ESI tip 106, in some embodiments, may include a hydrophilic surface 110, such as a metalized surface, which may help form a desirable configuration of an electrospray, such as a Taylor cone.

In some embodiments, microfluidic device 100 includes at least one hydrophilic surface and at least one hydrophobic surface. Either type of surface may be used in portions of substrate 102, cover 104 or both. Generally, such hydrophilic and hydrophobic surfaces allow substances to be sprayed from device 100 in a desired manner, for example to direct fluidic substance(s) toward a MS device while preventing the substance(s) from exiting outlet 113 from spreading along an edge or surface of device 100. At the same time, a hydrophilic surface on a microchannel 108 and/or tip 106 may help keep fluidic substance(s) generally moving along a desired path defined by the microchannel 108. Thus, a combination of hydrophilic and hydrophobic surfaces may be used to enhance ESI of substances to a device such as a mass spectrometer. For further description of such hydrophilic and hydrophobic surfaces, reference may be made to U.S. patent application Ser. No. 10/794,572 (Attorney Docket No. 021424-001610US), entitled “Microfluidic Devices and Methods,” filed Mar. 4, 2004, the full disclosure of which is hereby incorporated by reference.

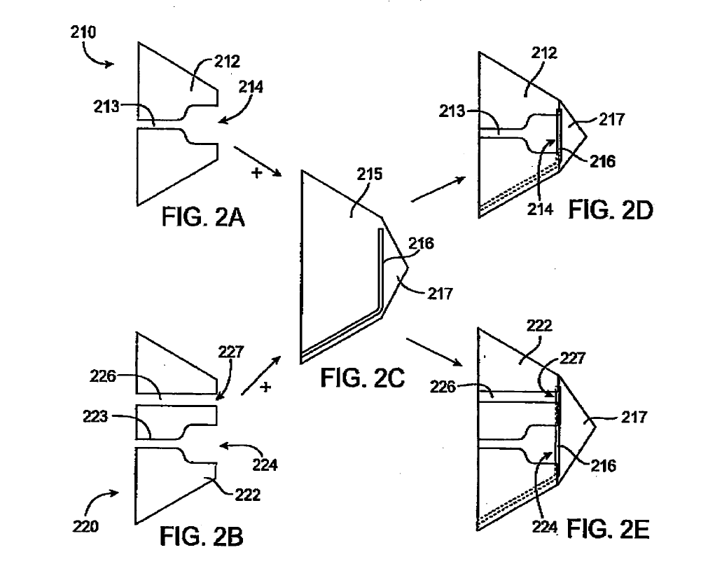

Referring now to FIGS. 2A-2E, portions of two embodiments of a microfluidic device 210, 220 are shown from a top view, demonstrating a simplified method for making microfluidic devices 210, 220. FIG. 2A illustrates one embodiment of a substrate 212, having a microchannel 213 with a widened outlet 214. The substrate 212 tapers as it approaches the outlet 214, as is the case in many embodiments. FIG. 2B shows another embodiment of a substrate 222, this embodiment including a microchannel 223 with a widened outlet 224, as well as an additional microchannel 226 with an outlet 227.

Referring to FIG. 2C, and as designated by the arrows with +signs, either substrate 212, 222 may be coupled with a cover 215 having an electrode 216 and a tip 217. The electrode 216 may comprise, for example, a conductive wire, a laminated metal trace, or the like. FIG. 2D illustrates the cover 215 coupled with the first substrate 212, and FIG. 2E shows the cover 215 coupled with the second substrate 222. In either embodiment, the electrode 216 of the cover 215 extends over the widened outlet 214, 224 of the substrate 212, 222. In some embodiments, the electrode 215 may also extend over additional outlet 227. The widened outlet 214, 224 helps to focus the electric field at the tip 217 for providing a desired electrospray while significantly reducing the possibility of an electric discharge between the electrode 216 and a counter electrode of a mass spectrometer orifice. Positioning the electrode 216 at the widened outlet 214, 224 also helps reduce the amount of bubbles generated in fluidic substances exiting the outlet 214, 224, since the electric field present in the fluid is reduced in proportion to the amount of widening. Embodiments like those shown may be used with or without electroosmotic flow.

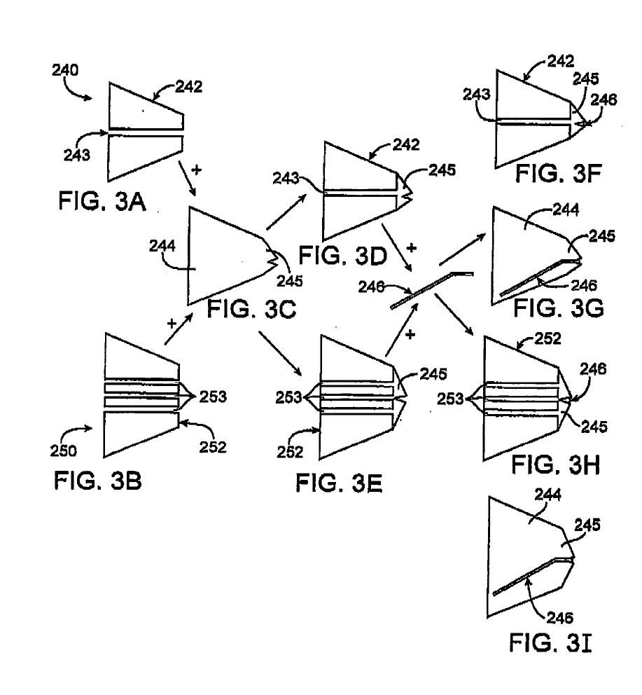

With reference now to FIGS. 3A-31, another method of making various embodiments of a microfluidic device 240, 250 is illustrated. FIG. 3A shows a tapered portion of a substrate 242 having one microchannel, while FIG. 3B shows a tapered portion of another embodiment of a substratge 252 having three microchannels 253. In FIG. 3, a cover 244 having a nib tip 245 is arranged on a surface of either substrate 242, 252, to form the substrate/cover combinations shown in FIGS. 3D and 3E. A conductive wire electrode 246 is then attached to the surface of the cover 244 that is opposite the substrate 252 to form the microfluidic device 240, 250. FIG. 3F is a top view of the first embodiment, showing the electrode 246 tip disposed in the nib tip 245 of the cover 244. FIG. 3G is a bottom view of the first embodiment, showing the electrode 246 attached to the bottom surface of the cover 244. FIGS. 3H and 31 are top and bottom views, respectively, of the second embodiment. Either embodiment may be used with or without electroosmotic flow.

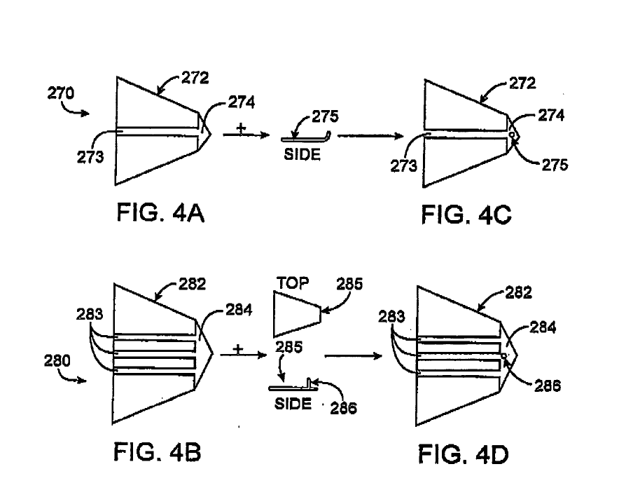

FIGS. 4A-4D illustrate two alternative embodiments for making a microfluidic device 270, 280. Referring to FIG. 4A, the tapered portion of one microfluidic device 270 includes a substrate 272 having a microchannel 273 and a cover having a tip 274. An electrode 275 may be attached to the bottom of the cover (not visible) such that a hooked portion of the electrode protrudes through the tip 274, as shown in FIG. 4C.

In another embodiment, illustrated in FIGS. 4B and 4D, a tapered portion of a microfluidic device 280 includes a substrate 282 having multiple microchannels 283 and a cover having a tip 284. An electrode 285 configured as a flat plate with a post member 286 may be attached to the bottom surface of the cover (not visible), such that the post member 286 protrudes through the tip 284, as in FIG. 4D. In either of the two embodiments just described, either the linear, hooked electrode 275 or the plate with post electrode 285 may be used. In various alternative embodiments, the electrode may have any other suitable configuration, size, shape or the like and may be made of any suitable material or combination of materials.

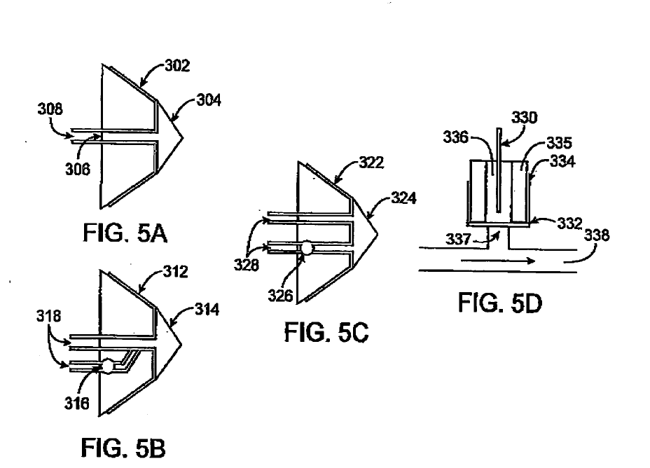

Referring now to FIGS. 5A-5D, another embodiment of a microfluidic device is illustrated. In FIGS. 5A-5C, a tapered portion of a substrate 302, 312, 322 is shown, having various configurations and numbers of microchannels 308, 318, 328 and coupled with a cover having a tip 304, 314, 324. In one microchannel 308, 318, 328 of each embodiment, a well 306, 316, 326 is disposed. In various embodiments, the well 306, 316, 326 may be placed in any suitable microchannel 308, 318, 328. In these embodiments, the well 306, 316, 326 provides the electrode function.

FIG. 5D illustrates an electrode well 334 in further detail. The well 334 is generally a hole formed in the substrate. Disposed in the well are a membrane 332 and a fixture 335 made of any suitable material and having any suitable configuration to hold the membrane 332 in place at the bottom of the well 334. A fluid 336, typically a buffer solution, is disposed in the well, and an electrode 330 is placed in contact with the fluid 336. The well 334 is in fluid communication with a smaller dimensions hole 337 in the substrate, which in turn is in fluid communication with a microchannel 338 of the substrate. However, the membrane 332 is configured to hold the fluid 336 within the well and prevent its passage into the hole 337. The membrane 332 includes nanopores to allow passage of ions but not other substances from well 334 into hole 337. In one embodiment, for example, the membrane 332 comprises a nanoporous polycarbonate material. Ions can pass through such a membrane 332 and continue along the path of the microchannel 338, thus providing the electrospray ionization function.

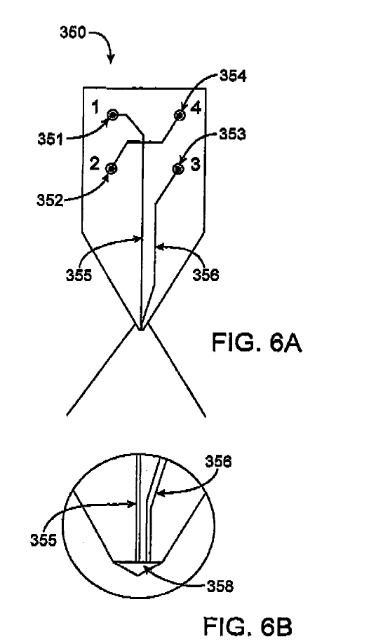

Referring now to FIGS. 6A and 6B, another embodiment of a microfluidic device 350 includes multiple wells and multiple microchannels 355, 356, with no electrode immediately at the tip 358 of the device 350. Separation of substances in a separation microchannel 355 and electrospray at the tip 358 are achieved by applying a voltage to well 1 351, which contains separation buffer, and well 3 353. The second microchannel 356 coupled with well 3 353 may be a sheath flow channel in some embodiments, while in other embodiments second microchannel may not have flow. Alternatively, voltage may be applied to well 1 351, well 2 352, well 4 354, and well 3 353. The applied voltages may be determined, for example, based on conductivity of the buffer solution, the dimensions of the separation microchannel 355 and/or the second microchannel 356, the electrospray needs at the tip 358, the electrospray mode (positive or negative), the separation performance, and the separation time window, and/or the like. In this embodiment, for charged coating in the sample loading and separation channels, it will often be desirable to limit or eliminate the amount of liquid flow in the second microchannel 356, or to influence its direction, in order to avoid analytes of interest moving into second microchannel 356, instead of being sprayed into a mass spectrometer. For neutral coating in the sample loading and separation channels, second microchannel 356 is coated with charged molecules in a control way to provide the solution for the electrospray from the tip and minimize the dilution at tip 358. This can be accomplished by a variety of methods, such as coating the walls of second microchannel 356 with a coating different from that used in the rest of the device. For instance, coating channel 355 with a positive wall coating and second microchannel 356 with a negative wall coating will result in an electroosmotic fluid flow coming from both channel 355 and second microchannel 356 and flowing to the tip 358 when a positive voltage is applied to well 3 relative to the voltage in well 1. Alternatively, a neutral coating may be used in second microchannel 356, with a positive coating elsewhere (or alternatively no coating, if the uncoated surface has sufficiently low electroosmotic flow). Another method to avoid loss of analyte in channel 356 is to place in that channel a membrane, gel, viscous solution, or any other component that allows the passage of electrically charged ions, but that stops or reduces liquid flow. Examples of such a substance are a cross-linked polyacrylamide, an agarose gel, or a viscous polymeric solution such as linear polyacrylamides, cellulose polymers, polyethylene oxide, polyvinylpyrrolidone, or other hydrophilic polymer solutions.

Several exemplary embodiments of microfluidic devices and methods for making and using those devices have been described. These descriptions have been provided for exemplary purposes only and should not be interpreted to limit the invention in any way. Many different variations, combinations, additional elements and the like may be used as part of the invention without departing from the scope of the invention as defined by the claims.

What is claimed is:

1. A microfluidic device for providing one or more substances to a mass spectrometer for analysis, the microfluidic device comprising:
a substrate comprising at least one layer, the substrate including at least one microchannel, wherein the substances are movable within the at least one microchannel;
a cover arranged on a surface of the substrate, the cover including at least one electrical potential source;
at least one outlet in fluid communication with the microchannel for allowing egress of the substances from the microchannel; and
at least one tip surface extending the cover beyond the outlet,
wherein the microchannel in fluid communication with the outlet widens from a first cross sectional dimensions along the majority of its length to a second, wider cross sectional dimensions at the outlet.

2. A microfluidic device as in claim 1, wherein the at least one microchannel is enclosed between the substrate and the cover.

3. A microfluidic device as in claim 1, wherein the at least one microchannel comprises at least two intersecting microchannels.

4. A microfluidic device as in claim 1, wherein the at least one microchannel comprises:
a first microchannel in fluid communication with a first outlet and having the first cross sectional dimensions and the second, wider cross sectional dimensions; and
at least a second microchannel in fluid communication with a second outlet disposed at the tip surface.

5. A microfluidic device as in claim 4, wherein the second microchannel includes at least one substance for preventing substances exiting the first outlet from entering the second outlet.

6. A microfluidic device as in claim 5, wherein the at least one substance in the second channel comprises at least one of a cross-linked polyacrylamide, an agarose gel, a linear polyacrylamide, a cellulose polymer, polyethylene oxide, polyvinylpyrrolidone and other hydrophilic polymer solutions.

7. A microfluidic device as in claim 4, wherein the second microchannel has negatively charged walls for directing a buffer through the second microchannel to prevent substances exiting the first outlet from entering the second outlet.

8. A microfluidic device as in claim 1, wherein the cover comprises at least one material selected from the group consisting of glass, silicon, ceramic, polymer, copolymer, silicon dioxide, quartz and silica.

9. A microfluidic device as in claim 8, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

10. A microfluidic device as in claim 1, wherein the at least one electrical potential source of the cover comprises a strip of material disposed across the outlet.

11. A microfluidic device as in claim 10, wherein the at least one electrical potential source comprises a strip of metal film.

12. A microfluidic device as in claim 10, wherein the at least one electrical potential source comprises a strip of conductive ink.

13. A microfluidic device as in claim 10, wherein the at least one electrical potential source is embedded in the cover.

14. A microfluidic device as in claim 10, wherein the at least one electrical potential source is coupled with the cover via adhesive.

15. A microfluidic device for providing one or more substances to a mass spectrometer for analysis, the microfluidic device comprising:
a substrate comprising at least one layer, the substrate including at least one microchannel, wherein the substances are movable within the at least one microchannel;
a cover arranged on a surface of the substrate and having a first surface in contact with the substrate and a second surface opposite the first surface;
at least one outlet in fluid communication with the microchannel for allowing egress of the substances from the microchannel;
at least one tip surface extending the cover beyond the outlet; and
at least one electrical potential source disposed on the second surface of the cover and ending near a distal end of the tip.

16. A microfluidic device as in claim 15, wherein the at least one microchannel is enclosed between the substrate and the cover.

17. A microfluidic device as in claim 15, wherein the at least one microchannel comprises at least two intersecting microchannels.

18. A microfluidic device as in claim 15, wherein the at least one microchannel comprises at least two microchannels, each in fluid communication with a different outlet.

19. A microfluidic device as in claim 15, wherein the tip includes a V-shaped edge surface for providing electrospray ionization of the substances to the mass spectrometer.

20. A microfluidic device as in claim 19, wherein one end of the electrical potential source is disposed at the V-shaped edge surface.

21. A microfluidic device as in claim 20, wherein the one end of the electrical potential source is recessed within the V-shaped edge surface.

22. A microfluidic device as in claim 19, 20 or 21, wherein the electrical potential source comprises a conductive wire.

23. A microfluidic device as in claim 15, wherein the tip includes at least one hole through the cover.

24. A microfluidic device as in claim 23, wherein the electrical potential source comprises a conductive wire shaped to extend into the hole.

25. A microfluidic device as in claim 23, wherein the electrical potential source comprises a conductive plate having a post extending into the hole.

26. A microfluidic device as in claim 15, wherein the cover comprises at least one material selected from the group consisting of glass, silicon, ceramic, polymer, copolymer, silicon dioxide, quartz and silica.

27. A microfluidic device as in claim 26, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

28. A microfluidic device as in claim 15, wherein the at least one electrical potential source is coupled with the cover via adhesive.

29. A microfluidic device for providing one or more substances to a mass spectrometer for analysis, the microfluidic device comprising:
a substrate comprising at least one layer, the substrate including:
at least one microchannel, wherein the substances are movable within the at least one microchannel; and
at least one electrode reservoir in fluid communication with the microchannel, the electrode reservoir having a membrane, conductive fluid separated from the microchannel by the membrane, and an electrode;
a cover arranged on a surface of the substrate;
at least one outlet in fluid communication with the microchannel for allowing egress of the substances from the microchannel; and
at least one tip surface extending the cover beyond the outlet.

30. A microfluidic device as in claim 29, wherein the at least one microchannel is enclosed between the substrate and the cover.

31. A microfluidic device as in claim 29, wherein the at least one microchannel comprises at least two intersecting microchannels.

32. A microfluidic device as in claim 29, wherein the at least one microchannel comprises at least two microchannels, each in fluid communication with a different outlet.

33. A microfluidic device as in claim 29, wherein the electrode reservoir comprises:
a reservoir portion containing the membrane, the conductive fluid and the electrode; and
a bridging channel between the reservoir portion and the microchannel, the bridging channel having a smaller dimensions than the reservoir portion.

34. A microfluidic device as in claim 33, wherein the membrane is disposed at a bottom of the reservoir portion, immediately adjacent the bridging channel, and wherein the membrane comprises nanopores configured to allow only small ions to pass through the membrane from the reservoir portion to the bridging channel.

35. A microfluidic device as in claim 34, wherein at least part of the electrode is disposed in the reservoir portion in contact with the conductive fluid.

36. A microfluidic device as in claim 34, further comprising a membrane fixture for holding the membrane in place at the bottom of the reservoir portion.

37. A microfluidic device as in claim 34, wherein the membrane is held in place at the bottom of the reservoir portion via adhesive.

38. A microfluidic device as in claim 29, wherein the cover comprises at least one material selected from the group consisting of glass, silicon, ceramic, polymer, copolymer, silicon dioxide, quartz and silica.

39. A microfluidic device as in claim 38, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

40. A microfluidic device for providing one or more substances to a mass spectrometer for analysis, the microfluidic device comprising:
a substrate comprising at least one layer, the substrate including:
at least a first microchannel, wherein the substances are movable within the first microchannel; and
at least a second microchannel coupled with an electrical contact,
wherein one of the first and second microchannels includes at least one substance for preventing the substances in the first microchannel from passing into the second microchannel;
a cover arranged on a surface of the substrate;
a first outlet in fluid communication with the first microchannel for allowing egress of the substances from the first microchannel;
at least a second outlet in fluid communication with the second microchannel for allowing electrical current from the second microchannel; and
at least one tip surface extending the cover beyond the outlet.

41. A microfluidic device as in claim 40, wherein the microchannels are enclosed between the substrate and the cover.

42. A microfluidic device as in claim 40, further comprising at least a third microchannel intersecting with the first microchannel.

43. A microfluidic device as in claim 40, wherein the at least one substance in the second microchannel comprises at least one of a cross-linked polyacrylamide, an agarose gel, a linear polyacrylamide, a cellulose polymer, polyethylene oxide, polyvinylpyrrolidone and other hydrophilic polymer solutions.

44. A microfluidic device as in claim 40, wherein the at least one substance in the second microchannel comprises a buffer, and wherein the second microchannel has negatively charged walls for directing the buffer through the second microchannel to prevent the substances exiting the first outlet from entering the second outlet.

45. A microfluidic device as in claim 40, wherein the first microchannel comprises positively charged walls, and the second microchannel comprises essentially neutral walls.

46. A microfluidic device as in claim 40, wherein the cover comprises at least one material selected from the group consisting of glass, silicon, ceramic, polymer, copolymer, silicon dioxide, quartz and silica.

47. A microfluidic device as in claim 46, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

48. A method of making a microfluidic device for providing one or more substances to a mass spectrometer for analysis, the method comprising:
fabricating a substrate comprising:
forming at least one microchannel having a microfabricated surface; and
forming an outlet in fluid communication with the microchannel and disposed along an edge surface of the substrate,
wherein the microchannel in fluid communication with the outlet widens from a first cross sectional dimensions along the majority of its length to a second, wider cross sectional dimensions at the outlet;
fabricating a cover having at least one tip surface; and
applying the cover to the substrate.

49. A method as in claim 48, wherein fabricating the substrate comprises forming at least two intersecting microchannels.

50. A method as in claim 48, wherein at least one of the substrate and the cover are fabricated from a material selected from the group consisting of glass, silicon, ceramic, polymer, copolymer, silicon dioxide, quartz, silica and a combination thereof.

51. A method as in claim 50, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

52. A method as in claim 48, wherein forming at least one microchannel comprises:
forming a first microchannel having positively charged walls; and
forming a second microchannel having essentially neutral walls.

53. A method as in claim 48, further comprising coupling an electrical potential source with the device to move the substances through the microchannel by electrophoretic or electrokinetic mobility.

54. A method as in claim 53, wherein the electrical potential source comprises an electrical potential microchannel, the electrical potential microchannel containing at least one electrically charged substance.

55. A method as in claim 54, wherein the electrical potential microchannel exits the microfluidic device immediately adjacent the microchannel.

56. A method as in claim 55, further comprising disposing at least one substance in the electrical potential microchannel for preventing substances exiting the outlet from entering the electrical potential microchannel.

57. A method as in claim 56, wherein the at least one substance in the electrical potential microchannel comprises at least one of a cross-linked polyacrylamide, an agarose gel, a linear polyacrylamide, a cellulose polymer, polyethylene oxide, Polyvinylpyrrolidone and other hydrophilic polymer solutions.

58. A method as in claim 56, wherein the at least one substance in the electrical potential microchannel comprises a buffer, and wherein the electrical potential microchannel has negatively charged walls for directing the buffer through the electrical potential microchannel.

59. A method as in claim 53, wherein the electrical potential source comprises at least one electrode on the microfluidic device.

60. A method as in claim 59, wherein the at least one electrode comprises a strip of material coupled with the cover so as to be disposed across the outlet.

61. A method as in claim 60, wherein the at least one electrode comprises a strip of metal film.

62. A method as in claim 60, wherein the at least one electrode comprises a strip of conductive ink.

63. A method as in claim 60, wherein the at least one electrode is embedded in the cover.

64. A method as in claim 60, wherein the at least one electrode is coupled with the cover via adhesive.

65. A method as in claim 59, wherein the at least one electrode provides potential for effecting at least one of electrophoretic separation of the substances and electrospray ionization.

66. A method as in claim 59, wherein the at least one electrode provides potential for effecting at least one of electrokinetic movement of the substances in the microchannel and electrospray ionization.

67. A method as in claim 59, wherein the at least one electrode comprises at least one of copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers.

68. A method as in claim 59, wherein the at least one electrode provides the electrical potential without producing a significant quantity of bubbles in the substances.

69. A method as in claim 48, further comprising:
making at least two connected microfluidic devices from one or more common pieces of starting material; and
separating the at least two microfluidic devices by cutting the common pieces of starting material.

70. A method as in claim 48, wherein the at least one microchannel is formed by at least one of photolithographically masked wet-etching, photolithographically masked plasma-etching, embossing, molding, compression molding, injection molding, photoablating, micromachining, laser cutting, laser ablation, milling, die cutting, reel-to-reel methods, photopolymerizing and casting.

71. A method of making a microfluidic device for providing one or more substances to a mass spectrometer for analysis, the method comprising:
fabricating a substrate comprising:
forming at least one microchannel having a microfabricated surface; and
forming an outlet in fluid communication with the microchannel and disposed along an edge surface of the substrate;
fabricating a cover having at least one tip surface, a substrate contacting surface, and an electrical potential surface opposite the substrate contacting surface;
coupling at least one electrical potential source with the electrical potential surface; and
applying the cover to the substrate.

72. A method as in claim 71, wherein fabricating the substrate comprises forming at least two intersecting microchannels.

73. A method as in claim 71, wherein at least one of the substrate and the cover are fabricated from a material selected from the group consisting of glass, silicon, ceramic, polymer, copolymer, silicon dioxide, quartz, silica and a combination thereof.

74. A method as in claim 73, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

75. A method as in claim 71, wherein the electrical potential source comprises at least one electrode.

76. A method as in claim 75, wherein fabricating the cover comprises forming a V-shaped edge surface in the tip surface, and wherein the electrode comprises a conductive wire with one end disposed in the V-shape.

77. A method as in claim 75, wherein fabricating the cover comprises forming a hole in the tip.

78. A method as in claim 77, wherein the electrode comprises a conductive wire shaped to extend into the hole.

79. A method as in claim 77, wherein the electrode comprises a conductive plate having a post extending into the hole.

80. A method as in claim 75, wherein the at least one electrode provides potential for effecting at least one of electrophoretic separation of the substances and electrospray ionization.

81. A method as in claim 75, wherein the at least one electrode provides potential for effecting at least one of electrokinetic movement of the substances in the microchannel and electrospray ionization.

82. A method as in claim 75, wherein the at least one electrode comprises at least one of copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers.

83. A method as in claim 75, wherein the at least one electrode provides the electrical potential without producing a significant quantity of bubbles in the substances.

84. A method of making a microfluidic device for providing one or more substances to a mass spectrometer for analysis, the method comprising:
fabricating a substrate comprising:
forming at least one microchannel having a microfabricated surface;
forming an outlet in fluid communication with the microchannel and disposed along an edge surface of the substrate; and
forming at least one electrode reservoir in fluid communication with the microchannel, the electrode reservoir having a membrane, conductive fluid separated from the microchannel by the membrane, and an electrode;
fabricating a cover having at least one tip surface, a substrate contacting surface, and an electrical potential surface opposite the substrate contacting surface; and
applying the cover to the substrate.

85. A method as in claim 84, wherein fabricating the substrate comprises forming at least two intersecting microchannels.

86. A method as in claim 84, wherein at least one of the substrate and the cover are fabricated from a material selected from the group consisting of glass, silicon, ceramic, polymer, copolymer, silicon dioxide, quartz, silica and a combination thereof.

87. A method as in claim 86, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

88. A method as in claim 84, wherein the electrode provides potential for effecting at least one of electrophoretic separation of the substances and electrospray ionization.

89. A method as in claim 84, wherein the electrode provides potential for effecting at least one of electrokinetic movement of the substances in the microchannel and electrospray ionization.

90. A method as in claim 84, wherein the electrode comprises at least one of copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers.

91. A method as in claim 84, wherein the electrode provides the electrical potential without producing a significant quantity of bubbles in the substances.

92. A method of making a microfluidic device for providing one or more substances to a mass spectrometer for analysis, the method comprising:
fabricating a substrate comprising:
forming at least one microchannel having a microfabricated surface; and
forming an outlet in fluid communication with the microchannel and disposed along an edge surface of the substrate;
fabricating a cover having at least one tip surface;
coupling an electrical potential source with the device to move the substances through the microchannel by electrophoretic or electrokinetic mobility; and
applying the cover to the substrate.

93. A method as in claim 92, wherein fabricating the substrate comprises forming at least two intersecting microchannels.

94. A method as in claim 92, wherein at least one of the substrate and the cover are fabricated from a material selected from the group consisting of glass, silicon, ceramic, polymer, copolymer, silicon dioxide, quartz, silica and a combination thereof.

95. A method as in claim 94, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

96. A method as in claim 92, wherein the electrical potential source comprises an electrical potential microchannel, the electrical potential microchannel containing at least one electrically charged substance.

97. A method as in claim 96, wherein the electrical potential microchannel exits the microfluidic device immediately adjacent the microchannel.

98. A method as in claim 97, further comprising disposing at least one substance in the electrical potential microchannel for preventing substances exiting the outlet from entering the electrical potential microchannel.

99. A method as in claim 98, wherein the at least one substance in the electrical potential microchannel comprises at least one of a cross-linked polyacrylamide, an agarose gel, a linear polyacrylamide, a cellulose polymer, polyethylene oxide, polyvinylpyrrolidone and other hydrophilic polymer solutions.

100. A method as in claim 98, wherein the at least one substance in the electrical potential microchannel comprises a buffer, and wherein the electrical potential microchannel has negatively charged walls for directing the buffer through the electrical potential microchannel.
